(19) United States
(12) Patent Application Publication
(10) Pub. No.: US 2026/0126972 A1
(43) Pub. Date: May 7, 2026

(54) DATA TRANSFORMATION SYSTEM

(71) Applicant: Healro CO., LTD., Taipei City (TW)

(72) Inventors: Ta Wei Huang, Taoyuan City (TW); Yu Ru Chen, Taipei City (TW); Ying Ju Lin, Taipei City (TW); Yu Ting Chen, Kaohsiung City (TW); David Chen, New Taipei City (TW); Shan Shan Liu, Taipei City (TW)

(21) Appl. No.: 18/938,638

(22) Filed: Nov. 6, 2024

(51) Int. Cl. G06F 8/40; G06F 40/205

(52) U.S. Cl. CPC G06F 8/40; G06F 40/205

(57) ABSTRACT

A data transformation system is provided for extracting source data and transmitting it to a transformation processing unit. The transformation processing unit transforms the source data into standard format data through a mapping profile. By collecting format descriptions of the source data and data examples, in cooperation with documentation and a specification file of a standard format and a specification file of the mapping profile, a language model algorithm is used to create the mapping profile.

### FIELD OF THE INVENTION

The present invention relates to a data transformation system, and more particularly, to a data transformation system that can transform various formats of source data into a standard format.

### BACKGROUND OF THE INVENTION

Data incompatibility between organizations and institutions poses a significant challenge to data integration. Variations in data formats prevent direct import into computer systems, necessitating costly and time-consuming manual programming (hard-coding) for data transformation. This approach not only increases development expenses and delays project timelines but also creates brittle, hard-to-maintain solutions that struggle to scale as data volumes and format variations grow.

Taiwan Utility Model Publication No. M650536 discloses a data exchange platform using artificial intelligence algorithms for data format transformation. However, this approach still requires substantial manual effort to construct initial mapping information. Specifically, providers of source data must manually define field correspondences between their data and the target standard format. Even with advancements in generative AI, automatically inferring these complex mappings across diverse schemas remains a significant challenge due to the resource-intensive nature of these models, often requiring significant computational power and time. This high resource consumption, coupled with the need for manual intervention, prevents fully automated data transformation. Therefore, existing solutions fall short of achieving seamless conversion of various source data formats into a unified standard.

### SUMMARY OF THE INVENTION

The primary object of the present invention is to provide a data transformation system that can transform various formats of source data into a standard format without the need to define mapping information individually.

In order to achieve the foregoing object, the data transformation system provided by

the present invention comprises a first server, a second server and a third server that are in data communication with each other.

The first server is in data communication with the second server. The first server has

a data source module and a transformation processing unit. The third server is in data communication with the second server. The third server has a built-in language model. The third server is configured for collecting format descriptions of source data and data examples, in cooperation with documentation and a specification file of a standard format and a specification file of a mapping profile. Through the language model, the mapping profile is created and stored in the second server.

The first server extracts the source data through the data source module and transmits it to the transformation processing unit. The transformation processing unit parses the mapping profile and transforms the source data into the standard format according to mapping instructions after parsing.

Preferably, the second server has a user management module. The user management

module provides an operation interface through which a user can create the mapping profile manually or modify the mapping profile created by the language model. When data mapping is set through the operation interface, the transformation processing unit extracts the source data in real time and transforms the format of the source data into the standard format according to the modified mapping profile and presents it in the operation interface in a visualized manner.

Preferably, the data transformation system further comprises a fourth server. The fourth server is in data communication with the first server. The fourth server has a database for storing transformed standard format data and a communication module for providing the standard format data through a standard protocol, so as to provide exchange and use of the standard format data.

### BRIEF DESCRIPTION OF THE DRAWINGS

FIG. 1 is a schematic view of the data transformation system of the present invention; and

FIG. 2 is a schematic view of the present invention when in use.

### DETAILED DESCRIPTION OF THE PREFERRED EMBODIMENTS

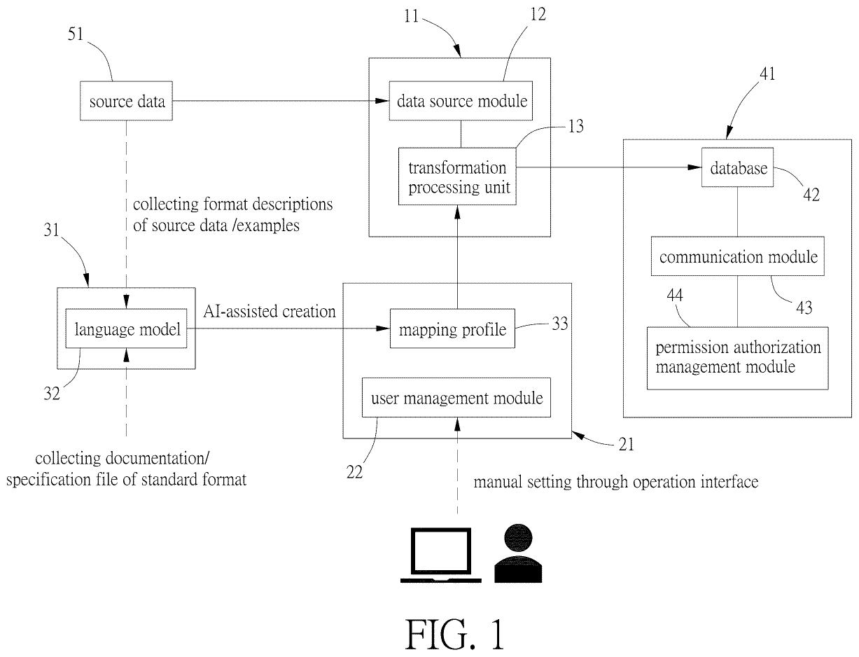

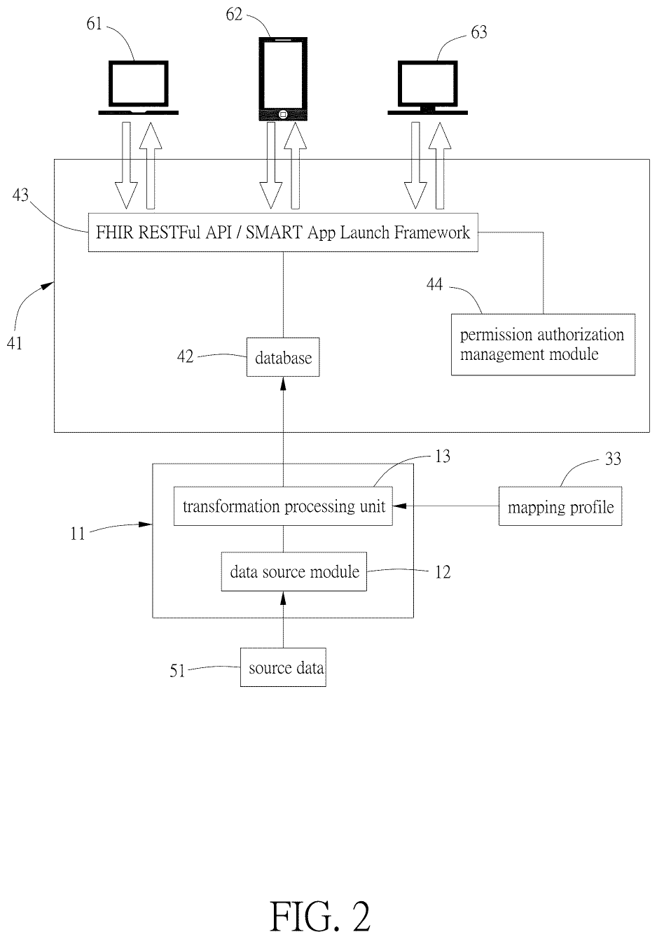

As shown in FIG. 1 and FIG. 2, the present invention discloses a data transformation

system, comprising a first server 11, a second server 21 and a third server 31 that are in data communication with each other.

The term “server” referred to by the first server 11, the second server 21 and the third server 31 is a device having at least a storage unit and a communication unit. The storage unit includes, but are not limited to, random access memory (RAM), read only memory (ROM), electronically-erasable programmable read-only memory (EEPROM), flash memory, or other memory technology, compact disc read-only memory (CD-ROM), digital video disk (DVD), other optical storage, magnetic cassettes, magnetic tape, and disk storage for use in storing data. The communication unit can implement computer-readable instructions, data, structures, application modules and other data into various data signals, and transmit them through wired transmission (such as, wired network or direct wired connection) or wireless transmission (such as audio, infrared, radio, microwave, spread spectrum technology and the like) to achieve data communication with other servers.

The first server 11 is in data communication with the second server 21. The first server 11 has a data source module 12 and a transformation processing unit 13. The data source module 12 is configured to obtain at least one source data 51 from an external source. The source data 51 may be structured or unstructured data from a database, a file or by calling an application programming interface (API) in a format that can be selected from the group consisting of extensible markup language (XML), JavaScript Object Notation (JSON), Resource Description Framework (RDF) and Terse RDF Triple Language (Turtle). The transformation processing unit 13 has a data computing and processing function and is mainly used to perform specific operations or tasks. Specifically, the transformation processing unit 13 may be a central processing unit (CPU), a microprocessor, a digital signal processor (DSP), a programmable controller, or a programmable logic device. (PLD) and other computing devices.

The third server 31 is in data communication with the second server 21. The third server 31 has a built-in language model 32. The third server 31 is configured to collect the format descriptions the source data 51 and data examples, in cooperation with collection of the documentation and specification file of a standard format and the specification file of a mapping profile 33. Through the language model 32, the mapping profile 33 is created and stored in the second server 21. The language model 32 may consist of a large language model (LLM) to form a deep learning model. The language model 32 is first trained to understand description files in various formats. Then, the language model 32 is fine-tuned by collecting the format descriptions (such as data tables or field names) of the source data 51 and the data examples, the specification file of the standard format, the specification file of the mapping profile 33 and the examples of the mapping profile file 33. The language model 32 learns from a large amount of data and automatically creates the mapping profiles 33 that transforms different data formats into a specific standard format without the need to define mapping data individually.

The first server 11 extracts the source data 51 through the data source module 12 and

transmits it to the transformation processing unit 13. The transformation processing unit 13 parses the mapping profile 33 and transforms the source data 51 into the standard format according to the fields and corresponding values defined in mapping instructions after parsing, and the transformed standard format is structured data.

Preferably, the second server 21 has a user management module 22. The user management module 22 is configured to provide an operation interface (not shown in the figures) through which the user can create the mapping profile 33 manually or modify the mapping profile 33 created by the language model 32. When data mapping is set through the operation interface, the transformation processing unit 13 extracts the source data 51 in real time and transforms the format of the source data 51 into the standard format according to the modified mapping profile 33, and presents it in the operation interface in a visualized manner (such as a table or a graph) so that the user can quickly determine the correctness of the transformed data. The transformed standard format data can be exported through downloading, saving to a specified storage space, or by calling an application programming interface of other systems.

Furthermore, the data transformation system provided by the present invention further comprises a fourth server 41. The fourth server 41 is in data communication with the first server 11. The fourth server 41 has a database 42 for storing the transformed standard format data and a communication module 43 for providing the standard format data through a standard protocol, so as to provide exchange and use of the standard format data.

In a feasible embodiment, the source data 51 may be medical record data of a medical institution. The standard format data is FHIR format data of the Fast Healthcare Interoperability Resources (FHIR) of the electronic medical information exchange standards published by Health Level Seven International (HL7). The communication module 43 is based on the FHIR protocol (FHIR RESTFul API) that implements standard data exchange to form a system framework based on the SMART App Launch Framework defined by the HL7 protocol, thereby enabling the fourth server 41 to constitute a medical data exchange platform as a medical application.

In the case of data transformation between different medical institutions, after the connection of the source data 51 is completed and the language model 32 creates the mapping profile 33, the transformation processing unit 13 transforms all kinds of structured and unstructured data from the medical institutions to electronic medical record data conforming to the data structure of the FHIR either in real time or in batches, enabling the access and exchange of medical information between different medical institutions to be more efficient and standardized. When the source data 51 is medical record data, the medical record data usually has a plurality of field items. The transformation processing unit 13 transforms the plurality of field items in batches into the standard format data that conforms to Fast Healthcare Interoperability Resources (FHIR) according to the mapping profile 33 and stores the standard format data in the database 42 of the fourth server 41 for an external device (such as a server computer 61, a mobile device 62 or a personal computer 63) to be in communication with the fourth server 41 through the communication module 43 to exchange the standard format data.

Preferably, in order to improve privacy and security during data exchange, the fourth

server 41 further has a permission authorization management module 44 that is in data communication with the communication module 43 to perform permission management on exchange and use of the standard format data. The permission management can manage read permissions by encrypting the data and/or by adding signatures, so as to ensure the privacy and security of the data effectively.

What is claimed is:

1. A data transformation system, comprising a first server, a second server and a third server that are in data communication with each other;
the first server being in data communication with the second server, the first server having a data source module and a transformation processing unit, the third server being in data communication with the second server, the third server having a built-in language model, the third server being configured for collecting format descriptions of source data and data examples, in cooperation with documentation and a specification file of a standard format and a specification file of a mapping profile, through the language model, the mapping profile being created and stored in the second server;
the first server extracting the source data through the data source module and transmitting it to the transformation processing unit, the transformation processing unit parsing the mapping profile and transforming the source data into the standard format according to mapping instructions after parsing.

2. The data transformation system as claimed in claim 1, wherein the source data is structured or unstructured data from a database, a file or by calling an application programming interface (API) in a format that is selected from the group consisting of extensible markup language (XML), JavaScript Object Notation (JSON), Resource Description Framework (RDF) and Terse RDF Triple Language (Turtle), and the transformed standard format is structured data.

3. The data transformation system as claimed in claim 1, wherein the second server has a user management module, the user management module provides an operation interface through which a user creates the mapping profile manually or modifies the mapping profile created by the language model, when data mapping is set through the operation interface, the transformation processing unit extracts the source data in real time and transforms the source data into the standard format according to the modified mapping profile and presents it in the operation interface in a visualized manner.

4. The data transformation system as claimed in claim 1, wherein the language model is first trained to understand description files in various formats, and then the language model is fine-tuned by collecting the format descriptions of the source data and the data examples, the specification file of the standard format, the specification file of the mapping profile and examples of the mapping profile file.

5. The data transformation system as claimed in claim 4, wherein the language model consists of a large language model (LLM), and the format descriptions of the source data are data tables or field names.

6. The data transformation system as claimed in claim 1, wherein transformed standard format data is exported through downloading, saving to a specified storage space or by calling an application programming interface of other systems.

7. The data transformation system as claimed in claim 1, further comprising a fourth server, the fourth server being in data communication with the first server, the fourth server has a database for storing transformed standard format data and a communication module for providing the standard format data through a standard protocol, so as to provide exchange and use of the standard format data.

8. The data transformation system as claimed in claim 7, wherein the source data is medical record data of a medical institution, the standard format data is FHIR format data of Fast Healthcare Interoperability Resources (FHIR), and the communication module is based on a FHIR protocol (FHIR RESTFul API) that implements standard data exchange to form a system framework based on the SMART App Launch Framework defined by a Health Level Seven (HL7), thereby enabling the fourth server to constitute a medical data exchange platform as a medical application.

9. The data transformation system as claimed in claim 7, wherein the fourth server further has a permission authorization management module that is in data communication with the communication module to perform permission management on exchange and use of the standard format data.

10. The data transformation system as claimed in claim 1, wherein the source data has a plurality of field items, and the transformation processing unit transforms the plurality of field items into the standard format data in real time or in batches according to the mapping profile.
